(19) United States
(12) Patent Application Publication
(10) Pub. No.: US 2005/0218052 A1
(43) Pub. Date: Oct. 6, 2005

(54) Abient noise power generator

(76) Inventors: Christina M. Houts, (US); Rex A. Crouch, (US)

Correspondence Address: Houts and Crouch, 1906 SEQUOIA STREET, TRAVERSE CITY, MI, 49686, US

(21) Appl. No.: 10/817,999

(22) Filed: Apr. 6, 2004

(51) Int. Cl. C02F 1/24; A01K 63/04

(52) U.S. Cl. 210/169; 210/221.2

(57) ABSTRACT

The Ambient Noise Power Generator converts ambient noises into electricity that may be stored in a voltaic cell for later use. The technique utilizes the laws of physics in which energy is neither created nor destroyed. Energy in the form of audio waves is captured and converted into electricity.

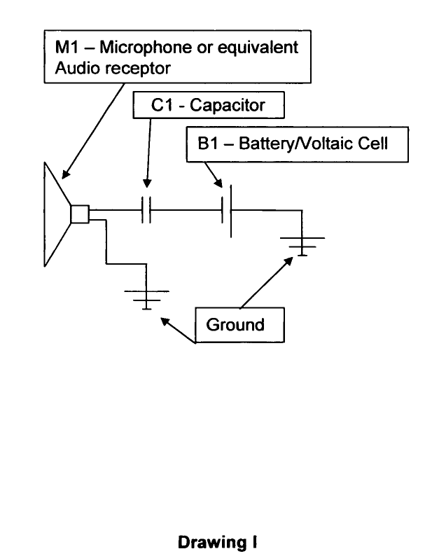

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

The Ambient Noise Power Generator is of Class 320 (Electricity: Battery or Capacitor Charging or Discharging) of which the general class subject matter provides for a method of discharging capacitors into voltaic cells and or batteries. The residual class for subject matter relates to a method for charging and or rejuvenating voltaic cells and or batteries through discharge of capacitors while utilizing an electromechanical device that converts audio waves into electrical waves such as microphones or audio speakers—said device will be referred to as the charging source. The output capacity of the charging source and the total potential charge of the capacitor will serve as the primary charging source control and regulation. Additional charging source controls and regulators may employ diodes, resisters, coils, filters, crystals, switches, integrated circuit to meet specific required outcomes. The charging source may be aided through the intensification of acoustics such as chambers and horns.

### BRIEF SUMMARY OF THE INVENTION

The Ambient Noise Power Generator in its most simple rudimentary form utilizes ambient noise to function the electromechanical portions of a microphone to produce electricity as the output. The amplitude modulated output electricity from the microphone (charging source) is collected by a capacitor and then discharged as a clean pulsating direct current which is used to supply, re-supply, charge, and or rejuvenate voltaic cells and or batteries.

### BRIEF DESCRIPTION OF THE SEVERAL VIEWS OF THE DRAWINGS

Drawing I is an electronic schematic depicting the basic form of the Ambient Noise Power Generator. Symbol M1 depicts the microphone (charging source). Symbol C1 depicts the capacitor. Symbol B1 depicts the battery voltaic cell, Symbol G1 depicts ground.

### DETAILED DESCRIPTION OF THE INVENTION

The Ambient Noise Power Generator uses a microphone or speaker (charging source) to receive audio waves and mechanically transfer the audio waves into electrical signals. The capacitor collects the electricity until capacitance is met and discharges the collected electricity as a pulsating direct current. The direct current is stored by a battery/voltaic cell. The construction of the Ambient Noise Power Generator should begin with the audio receiver being the microphone or speaker (a device that mechanically transforms audio waves into electrical waves—charging source). A capacitor is then selected. The capacitor must have a lower capacity then the charging source's maximum output to ensure a full charge is obtained and subsequently discharged into the battery/voltaic cell. The exact size of the capacitor is dependent on the size of the audio receiver and the desired rate of discharge into the battery/voltaic cell. The smaller the capacitor, the higher the rate of discharge into the battery/voltaic cell expediting battery/voltaic cell recharge time. The battery/voltaic cell must be a rechargeable cell and have a lower voltage capacity then the capacitor being used to ensure a full charge. This comprises a single unit of the Ambient Noise Power Generator. Ambient Noise Power Generator units may then be connected electronically in series to increase voltage and in parallel to increase amperage. The stored electricity may be employed in any manner as needed and as appropriate.

1. What we claim as our invention, the Ambient Noise Power Generator, transforms ambient noise into electricity. A single unit of our invention in test applications produces 0.05 volts of electricity from the ambient noise in a typical household room. Individual units of the Ambient Noise Power Generator, when connected electronically in series produce higher voltages. Individual units of the Ambient Noise Power Generator, when connected electronically in parallel, produce higher amperage. When the Ambient Noise Power Generator units are connected both in series and parallel (electronically), outputs of higher voltage and amperage are produced and may be used in residential and commercial applications. In lieu of allowing ambient noises to simply be absorbed by the objects around us, the Ambient Noise Power Generator will transform this acoustic energy into electricity and make the ambient environment quieter through acoustic absorption.
